(19) United States
(12) Patent Application Publication
(10) Pub. No.: US 2007/0003138 A1
(43) Pub. Date: Jan. 4, 2007

(54) Method for segmenting an image and an image transmission system and image transmission unit therefore

(76) Inventors: Paola Marcella Hobson, Basingstoke (GB); Timar Kadir, Oxford (GB); John Michael Brady, Oxford (GB)

Correspondence Address: Montorola Inc;Intellectual Property Department, 1303 E Algonquin Rd, Schaumburg, IL, 60196, US

(21) Appl. No.: 10/547,438

(22) PCT Filed: Feb. 27, 2004
(86) PCT No.: PCT/EP04/50219

§ 371 Date: May 16, 2006

(30) Foreign Application Priority Data
Mar. 3, 2003 (GB) 0304785.9

(51) Int. Cl. G06K 9/34

(52) U.S. Cl. 382/173

(57) ABSTRACT

A method (500) for segmenting an image comprises the step of identifying (502) one or more regions in the image. The method further comprises the steps of applying a single embedded surface for a Level Sets representation of said image; and performing region control logic (504) to enable said Level Sets, representation to manipulate one or more region boundaries in order to segment said image. This provides a method by which unsupervised image segmentation can be performed on an arbitrary number of classes/objects in the image.

### FIELD OF THE INVENTION

This invention relates to image transmission systems and methods for segmenting images. The invention is applicable to, but not limited to, a mechanism to segment an image in an unsupervised manner based on a Region Competition algorithm implemented in a Level Sets framework.

### BACKGROUND OF THE INVENTION

Future generation mobile communication systems are expected to provide the capability for video and image transmission, as well as the more conventional voice, and data services. As such, video and image services will become more prevalent and improvements in video/image compression technology will likely be needed in order to match the consumer demand within available bandwidth.

Current transmission technologies that are particularly suited to video applications focus on interpreting image data at the transmission source. Subsequently, the interpretation data, rather than the image itself, is transmitted and used at the destination communication unit. The interpretation data may or may not be transmitted in compressed form.

In the filed of image understanding and interpretation, it is known that segmentation is one of the key problems. The aim of segmentation is to partition an image into a number of disjoint regions (classes) that are homogenous in some attribute. In this regard, segmentation algorithms can use region and/or edge information to achieve the desired result. For example, in an aerial image, an application might be to segment the image into regions of similar land use. Different image attributes may be used to drive the segmentation of the image such as colour, intensity or motion.

In many known segmentation algorithms, the number of classes must be defined in advance. This means that the image identification system is allowed to find ‘N’ types of objects. For example, in a cell counting application, classes of white blood cells, red blood cells, and platelets may be defined as separate image objects to be identified when analysing a microscopic image. Such systems are known to be inflexible, inasmuch as they are unable to segment out extra objects, such as dirt on the microscope lens. Furthermore, the inflexibility extends to an inability for the system to be re-used for other problems, such as, say, biscuit counting.

In known segmentation methods, if the number of classes (distinct areas) and/or their attributes can be specified a-priori, problems in the classification of image attributes are defined as ‘supervised’. Otherwise, if the number of classes and/or their attributes cannot be specified a-priori, the problems in the classification of image attributes are defined as ‘unsupervised’.

There are at least three popular approaches to segmentation, each of which have been identified for different reasons as being unsuitable for unsupervised segmentation applications. A brief summary of the methods and associated problems is given below:

1. Snakes (Explicit Active Contours)

Use of Active Contour models, sometimes referred to as Snakes, is a known technique used to segment an image to identify objects of interest. A description of such a technique is described in ‘Snakes: Active Contour Models’ by M. Kass, A. Witkin and D. Terzopopoulos, International Conference on Computer Vision, pages 259-268, 1987. Active Contour models, or Snakes, is a technique that aims to find a contour in the image that balances image derived constraints, such as edge features, with prior knowledge constraints, such as contour smoothness or expected shape. The approach is an important one as it enables data fusion of bottom-up (image driven) and top-down (model driven) information in a very coherent and straightforward manner.

The parameterisation, which encodes the position and shape of the snake, may be simply a list of Cartesian coordinates relative to the image function. Alternatively, and more efficiently, a parametric representation such as B-Splines may be used, as known to those skilled in the art. Such a parameterisation method may encapsulate prior information about the form of the expected results. For example, if a B-Spline model is used, the degrees of freedom can be limited to constrain the final result to be of a particular shape.

A cost function may be, formulated from a physical model, where the contour has internal and external energy terms reflecting respectively the smoothness and image feature fit constraints. In this context, a cost function is one in which some definition of “cost” is assigned such that it can be minimised, with the desired results being the minimum possible value. As an example, transmitting an image “costs” bits, i.e. a certain number of bits need to be sent. Energy calculations are a mechanism for determining how much it will cost (in terms of bits, or contours, or entropy, etc.) to code the image.

When a cost function is applied to active contours, the energies are re-calculated as the contour is moved. A good segmentation algorithm would include a formulation of energy and a means to move the contour so that the cost function would be minimised when the contour matched the desired object.

Referring now to FIG. 1, a picture of two cars is shown, illustrating a problem in segmenting the individual care when using Snakes. To clarify the problem, let us consider a regions boundary being defined as a list of pixels. In a normal operation, the Snake is moved to minimise a specified energy function. However, as shown in FIG. 1, in certain cases Snakes need to be merged or split to arrive at the desired segmentation.

In their basic form, conventional Snakes are unable to perform such merging or splitting. For example, in FIG. 1 the preferred solution would be to arrive at a contour wrapped around each car. Since the initialisation was one contour around both cars 100, it will never converge to the desired result. The convergence of the contour still encompasses both cars, as shown in picture 110. Thus, the initial parameterisation limits the search space even though the gradient of the energy or cost function is negative. Hence, when Snakes are used, the result is very dependant on the initial curve (i.e. the initial set of image region boundaries).

2. Level Sets (Implicit Active Contours)

A methodology referred to as Level Sets has received a great deal of attention in recent years. The Level Sets approach has been popular, in large part, due to its ability to overcome the aforementioned limitations of the explicit Active Contour method.

In its basic form, a Level Set methodology provides an implicit contour representation that overcomes the traditional problems associated with explicit contour representations as used with conventional Snakes. As indicated above, a primary problem is using Snakes is in determining how to handle changes in topology such as merging and splitting. When applying a Level Sets approach, it is possible to perform merging and/or splitting, based on whether the global or local cost (or energy) is determined as moving up or down. If the merge operation decreases the energy, it is typically accepted, whereas if the merge operation makes the energy higher, it is typically rejected.

Level Set formulations of Snakes have been developed. In this regard, Level Set formulations of Snakes use an implicit representation of the contour. Instead of using an explicit parameterisation of the evolving front, the curve is embedded in a higher dimensional function, ψ. Conventionally, the signed (±) distance function is used:
ψ(x,t=0)=±d [1]
Where: d is the shortest distance from pixel location x to the contour. Note that the sign is set to differentiate between the inside and outside of the curve.

The contour is thus represented as the zero-level set of the function (the set of values for which the function is zero). The principal advantage of this scheme is that it can represent an arbitrary number of closed curves in a built-in manner. Referring now to FIG. 2, a pictorial example of a surface demonstrates the concept. The surface has been initialised as two circles. As the curve fronts evolve, in this case at a constant speed normal to the front, the circles grow and merge. Thus, different topologies can be represented in an elegant manner.

Consequently, the Level Sets approach provides advantages over the Snakes approach when applied to certain images. FIG. 3 shows the same car example of FIG. 1 using a Level Sets approach. The curve is able to split, as necessary, and the result is as desired, with a contour wrapped around each car.

The Active Contour methods described above usually use only edge terms to drive the segmentation. That is, the evolution operates using only the information at or near the contour front. In many cases, the use of region information is necessary to arrive at a useful result.

3. Region Segmentation

A recognised limitation of the conventional Level Set method extended to model regions is that it is only able to represent two region classes, corresponding to positive and negative regions of the embedded surface. In the ‘N’ class case, where ‘N’ can be greater than two, an alternative method must be used.

For the Level Set methodology, the widely adopted solution to a ‘N’ class scenario is to use a separate embedded surface for each class. This solution was first suggested in the document ‘A Variational Level Set Approach to Multiphase Motion’ by Zhao, H-K., Chan, T., Merriman, B. and Osher, S., Journal of Computational Physics 1996, vol. 127, pages 179-195. Multiple surfaces must be coupled in order to prevent overlap, where pixels are assigned to multiple classes (objects), and “vacuum”, which in this context refers to the case where pixels are not assigned to any class. The algorithm must be applied to all of these surfaces at each iteration.

In this regard, for a ‘N’ class problem, multiple functions are needed, resulting in ‘N’, regions being described at the end of the processing operation. Every pixel in the whole image has been allocated to one of those N classes, and notably there are no overlaps. This method demands large computational requirements in terms of both processing time and memory, especially in the case of three-dimensional applications.

However, of note in the context of the present invention, a further problem in such a methodology is that it requires the specification of the desired number of feature classes prior to segmentation. The limitation imposed by having to specify the number of classes means that the method is unsuitable for use in unsupervised applications.

Paragios, N. and Deriche, R. adopt this approach, representing each class of an image as the foreground of an embedded surface, in the document ‘Coupled Geodesic Active Regions for Image Segmentation: A Level Set Approach’, Proc. European Conference of Computer Vision, 2000. They address the need to specify the number of classes prior to the Level Set evolution part of the algorithm, by means of a first stage consisting of a clustering algorithm. This algorithm estimates the number of classes and their description (in this case the probability density functions (PDFs)).

However, the inventors of the present invention have recognised and appreciated significant drawbacks with this technique. In particular, the method is too reliant on the initial feature classification stage, to ensure a correct segmentation performance. An inaccurate initial feature classification will not account for variations in region attributes caused by shading and lighting effects.

Thus, if the components of the initial (mixture) model are not found correctly, then the method will not perform well. This is a reasonably common scenario in segmentation systems and is usually referred to as a training stage, where an initial model is generated based on starting with a similar image to the one expected. In this regard, segmentation following an initial classification stage cannot be termed an “unsupervised” segmentation method.

Furthermore, many segmentation problems require the simultaneous use of both spatial and feature information cues to arrive at a satisfactory result, for example in Texture segmentation problems. In such cases, a clustering algorithm, such as the one used by Paragios and Deriche, cannot correctly estimate the desired number of classes.

An alternative approach has been taken in a method proposed by T. Chan and L. A. Vese in ‘Image segmentation using level sets and the Mumford-shah model’ Technical report, UCLA—CAM, April 2000. Their method employs a cost function derived from the so-called Mumford-Shah image model whereby the underlying ideal image is the piecewise constant or so-called cartoon image. In this, each region is composed of a single intensity.

Also, this method that employs a cost function derived from the so-called Mumford-Shah image model requires log N embedded surfaces. This is a more efficient method than the aforementioned methods that require N embedded functions. In such an arrangement, their method only requires that the ‘MAXIMUM’ number of classes be specified a-priori. However, their method still requires this parameter. Hence, it may be considered as not being completely unsupervised.

Furthermore, log N embedded surfaces still present a very large memory requirement, especially for three-dimensional applications.

3a. Region Competition

A number of known unsupervised region segmentation algorithms do not use the Level Set methodology. One particularly relevant example is ‘Region Competition’, which was first introduced by S. C. Zhu and A. Yuille in ‘Region Competition: Unifying snakes, region growing, and bayes/mdl for multi-band image segmentation.’ IEEE Trans. on Pattern Analysis and Machine Intelligence, 18(9): p884-900, 1996. It is a very flexible unsupervised segmentation algorithm and has been applied to many segmentation tasks.

However, a conventional implementation of Region Competition, which commonly uses pixel lists of region membership, does not include a contour representation. Multiple regions can meet in many different ways. Hence, each way of arranging the multiple regions must be considered explicitly. This requires very careful coding, which is inefficient, as many exceptional cases must be considered when multiple regions compete.

Another problem is that the region model in standard Region Competition is parametric. In particular, each region is modelled by the mean and variance of a Gaussian distribution. In many images, this assumption is inappropriate and leads to poor robustness and ultimately to sub-optimal segmentations. Robustness in the sense used here means that the performance of the algorithm is not dependant on a critical setting of parameters.

Thus, there exists a need in the field of the present invention to provide an image transmission system, an image transmission unit and method for image segmentation that overcome/alleviate the problems associated with multiple surface Level Set methods. In particular, there exists a need to deal with unsupervised images in an efficient manner, and reduce the heavy computational requirements. Furthermore, there exists a need to alleviate the problems associated with standard implementations of Region Competition, which are inefficient due to the lack of a built-in contour model. There is also a need to provide a more flexible region model.

### STATEMENT OF INVENTION

In accordance with a first aspect of the present invention, there is provided a method for segmenting an image, as claimed in Claim 1.

In accordance with a second aspect of the present invention, there is provided a video or image transmission unit, as claimed in Claim 25.

In accordance with a third aspect of the present invention, there is provided a video or image transmission system, as claimed in Claim 26.

In accordance with a fourth aspect of the present invention, there is provided a storage medium storing processor-implementable instruction, as claimed in Claim 27.

Thus, in summary, the algorithm presented is novel in its reformulation of Region Competition inside a Level Sets framework. There are two key aspects of this reformulation:
(i) The use of a single embedded surface for the Level Sets representation and
(ii) The associated layer of region control logic, which enables the Level Set representation to perform the ‘COMPETE’ and ‘MERGE’ operations required by the Region Competition algorithm.

This combination brings a number of benefits from each approach. In particular, that Region Competition provides the flexibility of an unsupervised segmentation algorithm and the Level Set representation handles changes in topology and curve evolution in an elegant manner. The Level Sets approach, modified in accordance with the preferred embodiment of the present invention employs only one embedded surface, ψ, is not limited to two classes and can represent any number of disconnected regions. It is this arrangement together with its associated region control logic and Region Competition algorithm that facilitates the unsupervised operation of the proposed algorithm. Furthermore, it leads to a more efficient implementation, in particular with respect to memory requirements.

In addition, the standard Region Competition Gaussian region model is generalised to the non-parametric case. The non-parametric region model can represent a very wide range of image regions. This ultimately leads to a more robust algorithm and better segmentations.

### BRIEF DESCRIPTION OF THE DRAWINGS

FIG. 1 shows an image of two cars illustrating how a Conventional (explicit parameterisation) ‘Snakes’ approach is unable to handle changes in an image's topology;

FIG. 2 illustrates a known Level Set topology handling principle, where an embedded surface is shown in each sub-figure with the corresponding contour in the top-right of the sub-figures;

FIG. 3 is an image of two cars illustrating how a Level set formulation of Snakes is able to handle splitting (and merging) of changes in an image's topology in a natural way;

Exemplary embodiments of the present invention will now be described with reference to the accompany drawings, in which:

FIG. 4 shows a flowchart of a generic segmentation process, in accordance with a preferred embodiment of the present invention;

FIG. 5 shows a flowchart of an outer loop segmentation mechanism of the preferred embodiment of the present invention;

FIG. 6 illustrates a flowchart of a first phase of the segmentation mechanism of the preferred embodiment of the present invention;

FIG. 7 illustrates a flowchart of a second phase of the segmentation mechanism of the preferred embodiment of the present invention;

FIG. 8 illustrates a flowchart of a third phase of the segmentation mechanism of the preferred embodiment of the present invention;

FIG. 9 illustrates a flowchart of a fourth phase of the segmentation mechanism of the preferred embodiment of the present invention;

FIG. 10 illustrates a series of images showing how the segmenting of an example image is performed according to the preferred methods of the present invention; and

FIG. 11 shows a profile view of a slice of a simple ψ function to illustrate the region and boundary definitions used in the preferred methods of the present invention.

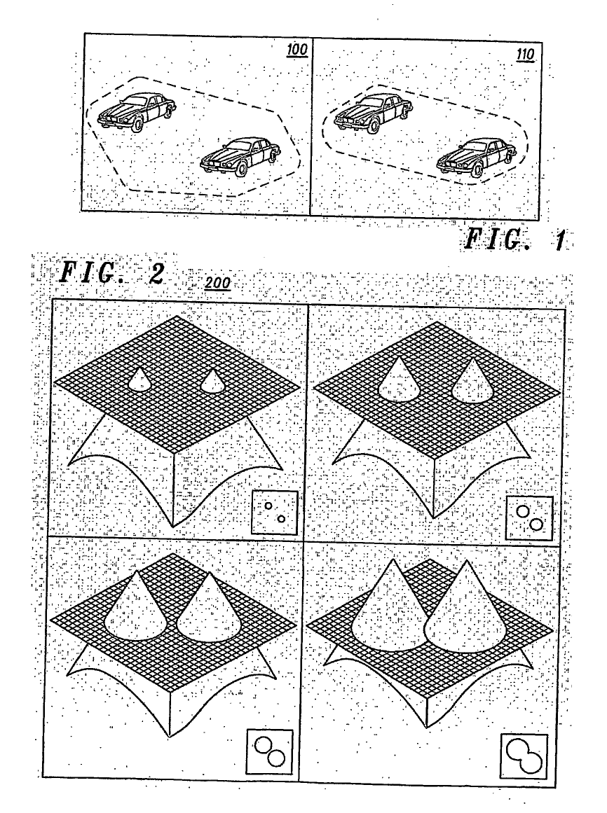

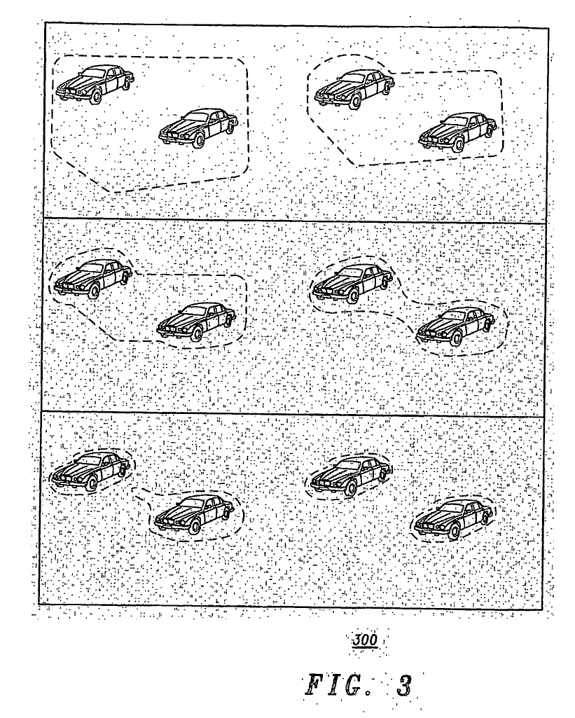

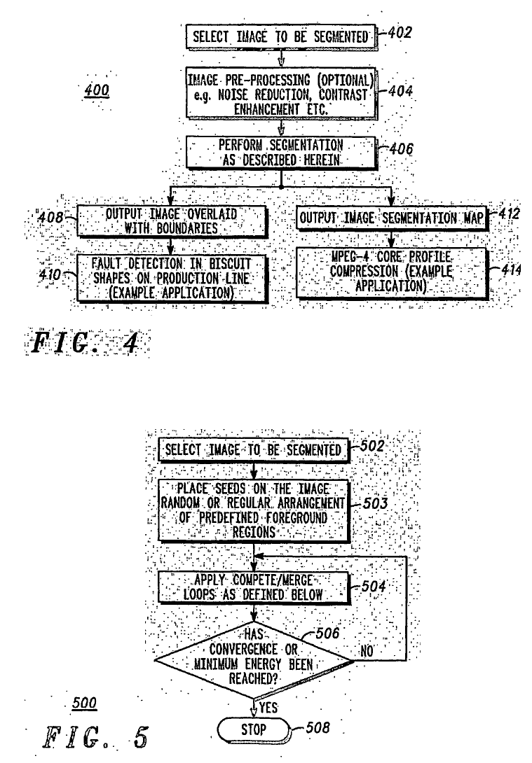

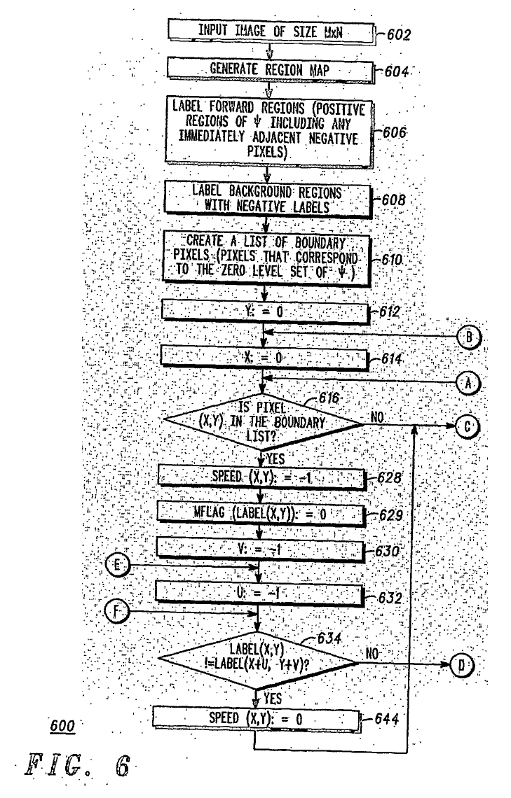

### DESCRIPTION OF PREFERRED EMBODIMENTS

The preferred embodiment of the present invention is essentially a process of image understanding and interpretation, by means of segmenting regions within an image. In summary, the inventive concepts of the present invention, as described below, overcome the limitation of the prior art approaches by re-formulating the Region Competition algorithm inside a Level Sets framework. The preferred region model is generalised to a non-parametric case. In this manner, the preferred embodiment benefits from advantages of the respective individual methods.

Advantageously, the algorithm of the present embodiment is able to solve N-class segmentation problems where N can be greater than two, using just one embedded surface. This is achieved by the region control, which controls the merging and splitting behaviour of the zero level set by means of the contour speed function. This is done in accordance with the Region Competition cost functions and the state of the embedded surface.

The cost functions in the conventional Region Competition algorithm comprise three elements. The first element is the regions model itself. In a particular implementation, the pixels within each region are modelled as samples from a Gaussian PDF. The mean of this Gaussian PDF corresponds to the piece-wise constant intensity of the underlying ‘ideal’ image and the variance corresponds to the residual error or noise.

The second element of the model is the overhead cost associated with the region model. Each region costs some bits to encode; the fewer regions, the lower the cost. Of course, this is traded off against the cost of including pixels in a single region. For example, if pixels from two adjoining regions are merged, then the total number of regions is reduced. Hence, the region model cost is reduced. However, the pixel cost within the region may have increased if the new pixels are not modelled well by the single PDF.

The third element of the model is the boundary cost, i.e. the cost associated with coding the length of a region's boundary. The shorter the boundary of a region, the lower is the cost.

The Level Set representation of the preferred embodiment of the present invention handles changes in topology and curve evolution in an elegant manner. Advantageously, the combination of using a single embedded surface and controlling the region and contour merging by means of region control logic and the Region Competition cost functions, allow the method to operate in an unsupervised manner, i.e. it is necessary to specify neither the value of N nor the class models a-priori.

This is in contrast to known N-class region based Level Set segmentation methods, which operate by evolving multiple coupled embedded surfaces in parallel. These known methods require the specification of parameters such as the maximum class number, and sometimes the classes themselves, i.e. some mathematical description of what defines each class, to be known a-priori.

Also, the single embedded surface is computationally more efficient than the multiple surface alternatives that are known in the art.

The inventive concepts of the present invention find particular applicability in the fields of fault detection (industrial inspection), automated pattern or object detection (image database searching), terrain classification (military and environmental aerial images), and object recognition (artificial intelligence).

The inventors of the present invention have both recognised and appreciated that the main problem in known multiple-class Level Set segmentation methods as being essentially one of representation with the original Level Set approach being only able to represent two classes: inside and outside regions of a zero level set. These are considered as foreground and background in the region based Level Set implementations. Therefore, the inventors have proposed a solution whereby disconnected regions are considered separately.

The proposed solution is, in essence, to use a pixel-labelling algorithm to extract the separate regions, at each iteration of the curve evolution. The theory behind this methodology is that a contour is implicitly defined by the surface, i.e. all values for which the surface is equal to zero, is defined to be the coutour.

In practice, this actually achieved by looking for zero crossings. Preferably, by assigning the same label to all ‘connected’ pixels that have the same polarity, the pixel labelling methodology is extended. By definition, a curve or region boundary occurs at a change in polarity. By assigning neighbouring pixels with the same label, each region is configured so that it is able to grow or shrink to minimise the global cost function.

It is envisaged that an alternative mechanism could be to use different level sets of a surface to represent different regions. The key to such an alternative mechanism would be to set up the correct evolution equations, as would be appreciated by a person skilled in the art.

Once a pixel-labelling algorithm is used at each iteration of the curve evolution, to extract the separate regions, the only remaining task is to control the merging and competition parts of the algorithm. This is achieved by setting the appropriate speeds on the embedded surface.

One of the major benefits of the Level Set approach is that merging and splitting is handled inherently. However, in a Region Competition algorithm, the inventors have determined that this has to be controlled in such a way that merging is only allowed if the global cost is reduced.

Therefore, the inventors propose a mechanism by which curves (and consequently regions) compete or are merged according to a global cost determination. In particular, the preferred algorithm detects when two or more foreground regions come into contact. Thereafter, depending on the outcome of a merge cost calculation, the algorithm allows the regions to merge or causes them to compete over the Boundary pixels.

The approach requires some careful definitions and coding. These are detailed in the following sections.

Regions and Boundary Definition

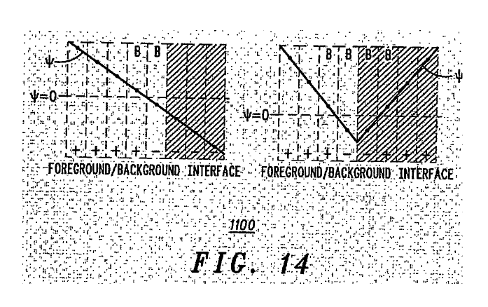

Referring now to FIG. 11, a profile view of a slice of a simple ψ function illustrates the region and boundary definitions used in the preferred methods of the present invention. Two types of region are defined. Foreground and Background, which generally correspond to positive and negative regions in the embedding surface ψ respectively. Both types are treated in an identical manner by the cost function.

However, it is necessary to distinguish between the positive and negative regions, as the ‘COMPETE’ and ‘MERGE’ operations are different for each of these. Foreground regions are defined as those where the embedding surface ψ>0, but also include the negative or zero boundary terms adjacent to it. This is necessary in order to allow the region to both grow and shrink; to grow outwards a positive region has to increase (above zero) those pixels beyond its positive boundary. To allow the regions to shrink it must reduce below zero those pixels at the edge of its positive boundary. Background regions are simply defined as those regions where ψ<0.

Boundary pixels are those pixels for which the embedded function ψ is zero. In practice, ψ is rarely zero except at ‘initialisation’. Hence, Boundary pixels are defined to be those pixels that straddle a polarity change in ψ. A noteworthy point is that in this arrangement, Foreground pixels include Boundary pixels.

The Level Set evolution equation in the algorithm of the preferred embodiment of the present invention is:
Φ=Φ−F_{Region}|∇Φ|*dt [2]
Where: F_{Region} is the speed function, and is instantiated as described below.

It is noteworthy that the conventional curvature dependent term is not included, as the inventors have appreciated that it would create problems for the region ‘MERGE’ and ‘COMPETE’ logic. Therefore, the inventors have determined that the conventional curvature dependent term is preferably included as a boundary cost as part of the cost functions that govern the region forces.

Merging and Competition

In conventional implementations of the Region Competition algorithm, region boundaries are defined implicitly by the pixel membership sets and proceed in an iterative manner. At each iteration, region membership sets are adjusted such that the global cost function is reduced. Only the pixels at the boundaries of two (or more) regions are tested and, if necessary, adjusted. The effect is that the implied boundaries between two (or more) regions are moved in order to achieve a minimum in global cost.

The Level Set algorithm of the preferred embodiment of the present invention also operates iteratively. However, the algorithm adjust the region boundaries directly since the Level Set methodology is essentially a contour representation. The contours represent the boundaries between regions and are defined by the zero-level set of the embedded surface, ψ. The boundaries can be moved by setting the appropriate speed function (F_{Region}) values to change the embedded surface, ψ.

Hence, the values will move the boundaries of the regions such that the global cost function is reduced. In common with a conventional implementation of Region Competition, the cost functions are only evaluated for each location in the image that corresponds to a boundary in the embedded function, ψ.

The speed function is applied to the embedded surface by means of the Level Set evolution equation shown in equation [2].

For the COMPETE part of the algorithm, the change in global cost (ΔE_{x,y}) at a particular Boundary pixel x=(x,y), for the Gaussian region model, is calculated according to:

$$Δ {E}_{( x , y )} = log \frac{{σ}_{i}^{2}}{{σ}_{j}^{2}} + ( \frac{{( {\overline{I}}_{( x , y )} - {μ}_{i} )}^{2}}{{σ}_{i}^{2}} - \frac{{( {\overline{I}}_{( x , y )} - {μ}_{j} )}^{2}}{{σ}_{j}^{2}} ) + ( \frac{{S}_{( x , y )}^{2}}{{σ}_{i}^{2}} - \frac{{S}_{( x , y )}^{2}}{{σ}_{j}^{2}} ) \qquad [ 3 ]$$

Where: I_{(x,y)} and S_{(x,y)} are the mean and variance in a local window around the location of the Boundary pixel, x=(x,y). The size of this local window must be determined empirically and is generally fixed at the outset. μᵢ and σᵢ and μⱼ and σⱼ are the means and variances of the two regions (‘i’ and ‘j’) which are immediately adjacent to the Boundary pixel x=(x,y). In other words, the boundary at x=(x,y) separates regions i and j.

The MERGE part of the algorithm evaluates potential merges of two adjacent regions, i and j, by checking whether such a merger would result in a reduction of the global cost. For the Gaussian region model, this is calculated according to:

$$Δ {E}_{M} = - λ + \frac{1}{2} ( {n}_{{ℛ}_{i}} log \frac{{σ}_{ij}^{2}}{{σ}_{i}^{2}} + {n}_{{ℛ}_{j}} log \frac{{σ}_{ij}^{2}}{{σ}_{j}^{2}} + 1 ) \qquad [ 4 ]$$

Where: n_{Ri} and n_{Rj} are the numbers of pixels in regions ‘i’ and ‘j’ respectively, and λ is the region overhead cost parameter that effectively controls the likelihood of region merges. A higher value of λ encourages fewer regions. μᵢ and σᵢ, and μⱼ and σⱼ, and μᵢⱼ and σᵢⱼ are the means and variances of the regions i and j and the potential union of i and j respectively, whose merger is being tested.

In essence, the purpose of the MERGE operation is to overcome local minima in the search space. For example, the local boundary competition arrives at a steady state between two regions, whereas a lower global cost might be achieved through merging the regions.

It should be noted that merges must be restricted such that only unique pairs of regions are merged at any single iteration. This is necessary because the algorithm operates in a local manner, where each pair of merge candidates is tested independently. Thus, two regions may be inadvertently merged via simultaneous merges to third region. In the preferred embodiment of the present invention, this is achieved by means of a flag for each region set. The flag is used to indicate the label of the region to which it is to be merged. Otherwise, the flag is set to zero. Each MERGE operation then tests the merge flag of each region in the pair of regions under consideration before proceeding to the merge operation.

Region Control Logic

The two stages of the Region Competition algorithm, namely ‘COMPETE’ and ‘MERGE’, require different operations depending upon whether adjacent regions are designated as Foreground or Background.

In order to produce the correct behaviour, it is first necessary to detect whether the regions adjacent to the Boundary pixel are Foreground or Background regions. This is achieved by conducting a local search in an eight-neighbourhood around the Boundary pixel under consideration.

The aforementioned descriptions and definitions of Foreground and Background and their associated positive and negative labelling schemes facilitate this stage. Foreground regions are deemed present where any of the pixels within the eight-neighbourhood have a positive label that differs from that of the Boundary pixel under consideration. Conversely, Background regions are deemed present where any of the pixels have a negative label, which differs from that of the Boundary pixel under consideration.

The appropriate speed setting for the current Boundary pixel for the MERGE and COMPETE operations in each case of Foreground versus Background and Foreground versus Foreground are specified below:

Foreground Versus Background

For the COMPETE operation the speed at Boundary pixel x=(x,y) is set according to:

$${ℱ}_{Region} ( x , y ) \{ \begin{matrix}-= 1 & if Δ {E}_{( x , y )} <= 0 \\ += 1 & if Δ {E}_{( x , y )} > 0\end{matrix} \qquad [ 5 ]$$

Equation [3] tests how statistically similar a Boundary pixel (and its local neighbours) is to each of the adjacent regions, i and j. Equation [5] sets the speed of the boundary pixel at x=(x,y) according to whether the statistics of the Boundary pixel and its surrounding neighbourhood are more similar to those of region i or j. If they are more similar to region i, then region i should grow. This is achieved by adjusting the boundary such that it moves into region j. In turn, this is achieved by decreasing the value of the speed function at Boundary pixel x=(x,y) by ‘1’.

Conversely, if the statistics are more similar to those of region j, then the value of the speed function should be increased by ‘1’. In this manner, increments and decrements are used to facilitate a form of “voting” at each boundary location. In equation [5] these increment and decrement operations are denoted as ‘+=1’ and ‘−=1’ respectively.

The merger between the two regions adjacent to x-32 (x,y) is allowed to proceed if it would result in an overall cost reduction. In other words, the merger will proceed if ΔEM_{x,y}<0, as calculated according equation [4]. The inventors have found that there is no elegant manner by which a Foreground and Background region can be merged in a single step. Instead, the speed function is set according to:

$${ℱ}_{Region} ( x , y ) = \{ \begin{matrix} - 1 & if Δ {E}_{M} < 0 \\ COMPETE & if Δ {E}_{M} >= 0\end{matrix} \qquad [ 6 ]$$

If a Foreground region and a Background region are to be merged then the speed for the Boundary pixel x=(x,y) is set to “−1”, i.e. it is set to grow. Since Boundary pixels are, by definition, also Foreground regions this has the effect of forcing the Foreground region to grow into the corresponding Background region. If ΔEM_{x,y}>=0, that is the global cost does not decrease if the two regions ‘i’ and ‘j’ are merged, then the speed should be set according to the COMPETE speed equation [5].

Foreground versus Foreground

For the Foreground versus Foreground COMPETE operation, it is required that one region pushes the other away if it causes the global cost to be reduced.

Therefore, in the preferred embodiment of the present invention the algorithm causes the regions(s) with the weaker statistical force to shrink, i.e. the algorithm sets their speeds to ‘+1’. In contrast, the stronger regions are not modified. In this context, the terms ‘strong regions’ and ‘weak regions’ refer to the statistical similarity of a Boundary pixel (and its local neighbours) to any of the regions nearby, i.e. ‘strong’ indicates that it is very similar, whereas ‘weak’ indicates that it is substantially dissimilar.

For the MERGE operation, nothing needs to be done. This is because the normal Foreground versus Background COMPETE operation will cause the two regions to merge.

Boundary Clean Up

Since Foreground regions are defined to include Boundary pixels, boundary pixels from Foreground regions that merged, or Background regions that previously merged into Foreground regions, remain in the boundary map. Effectively, they are not removed, as they are both foregrounds that emanate from the same region. Hence, they have the same label. Therefore, the normal COMPETE and MERGE parts of the algorithm are not applied to them. This is not a significant problem because the region map does not pick up these points. However, it does cause the boundary map to be somewhat confusing.

The inventors of the present invention have resolved this potential confusion by causing all Boundary pixels that meet other Boundary pixels from the same region to grow. This cannot be done after the main COMPETE/MERGE processing as each pixel at the front is, by definition, next to a Boundary pixel of the same region. Setting these to grow as well would cause the front to grow regardless of the global cost.

Instead, the algorithm preferably sets the speed to ‘−1’ prior to the MERGE/COMPETE operations. In this way, and advantageously, the preset grow speed is overridden at any position where the global cost is affected.

The whole algorithm is described below with respect to the following flowcharts.

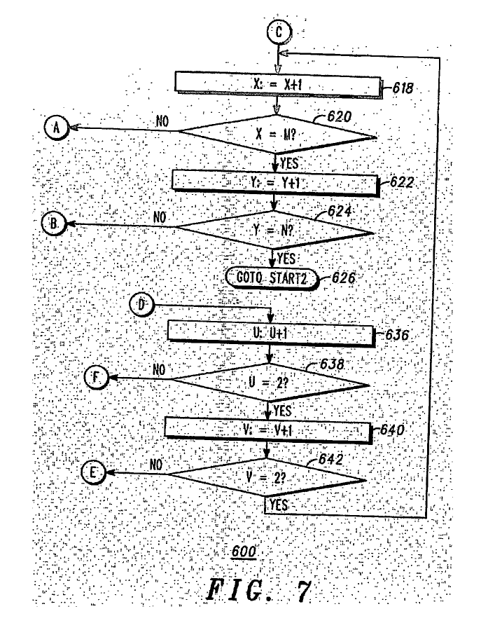

Referring now to FIG. 4, a flowchart 400 of the generic process of the preferred segmentation method is described, with respect to two potential applications. The process commences in step 402 with the selection of an image to be segmented.

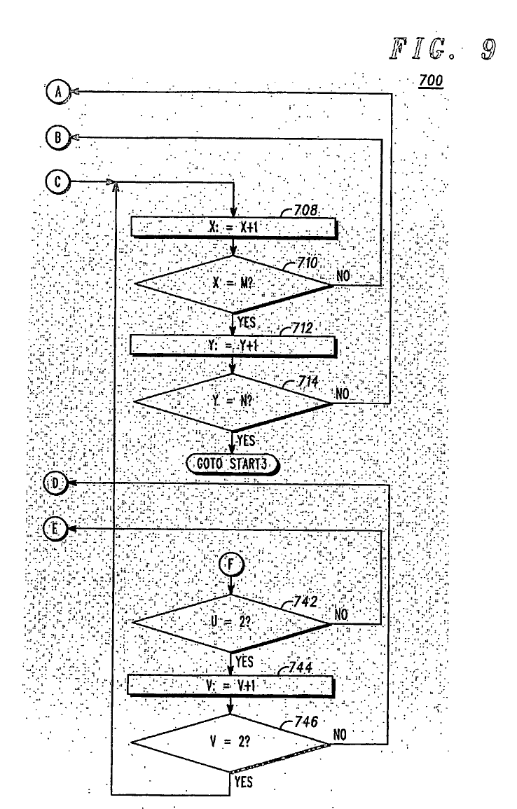

Preferably, some image pre-processing may be applied to the image, prior to segmentation, as shown in step 404. In this manner, the image may be improved to assist the segmentation process by, for example, performing known techniques for noise reduction, contrast enhancement, etc. Segmentation is then performed as described with respect to FIGS. 6-9, as shown in step 406.

Dependent upon the image being segmented, the output image may be overlaid with boundaries, as shown in step 408. In this regard, a potential application would be fault detection, for example in determining biscuit shapes in a production line, as in step 410. Alternatively, the output image may comprise a segmentation map, as in step 412. In this regard, the segmented image may be used as part of a MPEG-4 core profile compression of a video sequence, in step 414.

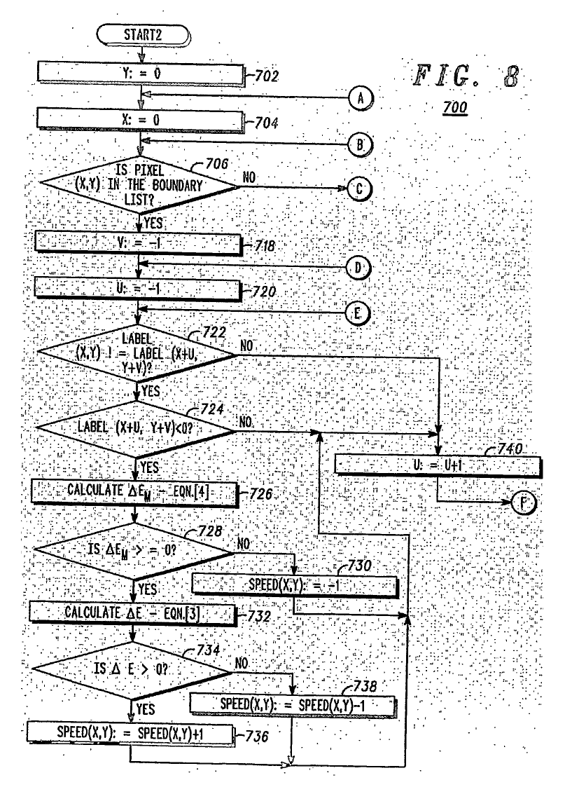

Referring now to FIG. 5, a flowchart 500 describes an “outer loop” mechanism used in the preferred segmentation process. In this regard, the process commences in step 502 with the image selected for segmentation. Next, the embedded surface ψ is initialised. This can be achieved, using techniques known in the Level Sets literature, as follows.

The size of ψ is set to the size of the image to be segmented. The exact values of ψ at each location are defined by the signed distance function, as shown in equation [1]. This equation sets ψ at a particular location to a value, which represents the minimum Euclidian distance from the location to the desired initial contour locations.

These initial contour locations are also referred to as ‘seeds’ and may be placed randomly, on a regular grid or by some other means, as shown in step 503. The segmentation process includes applying ‘COMPETE’ and ‘MERGE’ loops as defined above and with respect to FIG'S. 6-9, in step 504. The ‘COMPETE’ and ‘MERGE’ loops are repeated in step 506 to step 504 until the algorithm converges, i.e. stable boundary descriptions are reached, or until some pre-defined minimum total energy threshold is achieved.

Referring now to FIG. 6, a flowchart 600 illustrates a first phase of the segmentation process in accordance with the preferred embodiment of the present invention. The process commences, in step 602, with an image of ‘M’*‘N’ pixels being selected for segmentation.

In accordance with the preferred embodiment of the present invention, a region label map is generated using a standard pixel-labelling algorithm that labels connected regions with the same label, as shown in step 604. An example of such an algorithm can be found in E. Gose, R. Johnsonbaugh, and S. Jost, ‘Pattern Recognition and Image Analysis’, published by Prentice-Hall in 1996.

The size of this region map is the same as that of the image to be segmented and the embedded surface, ψ. In this manner, locations in the region map correspond to location in the image and the embedded surface, ψ. The criterion for determining whether a region is connected is defined in the following manner.

Each location in the embedded surface ψ is identified as Foreground or Background. Foreground regions are assigned positive integer labels in the region map and Background regions are assigned negative integer label in the region map. Foreground regions are defined as positive regions of the embedded surface ψ, including any immediately adjacent negative pixels, and given a positive label in the region map, in step 606. Negative regions of ψ, which do not correspond to Foreground, are labelled as Background regions and are assigned negative labels in the region map, in step 608. In this manner, each non-overlapping regions in the region map is assigned an individual integer label.

Next, the locations that correspond to the zero level set of ψ are identified as Boundary pixels, as shown in step 610. In practice, locations in ψ are unlikely to correspond to zero exactly. The zero level set must therefore be found by identifying zero-crossings, that is where ψ crosses from negative to positive.

In the implementation described here, the boundary pixels are defined as both the positive and negative pixels that straddle a zero-crossing. A list of defined Boundary pixels is stored in step 610, and updated in each iteration of the algorithm. As indicated earlier, such an operation is illustrated graphically in FIG. 11.

A noteworthy point is that by definition Boundary pixels are also Foreground pixels. However, the converse is not true.

In the preferred embodiment here disclosed, the steps of identifying and labelling pixels to create the region map and the boundary list are carried out at each iteration of the method. However, omitting these steps and instead updating the boundary list and region map at the end of each iteration of the algorithm could equally effect the same result.

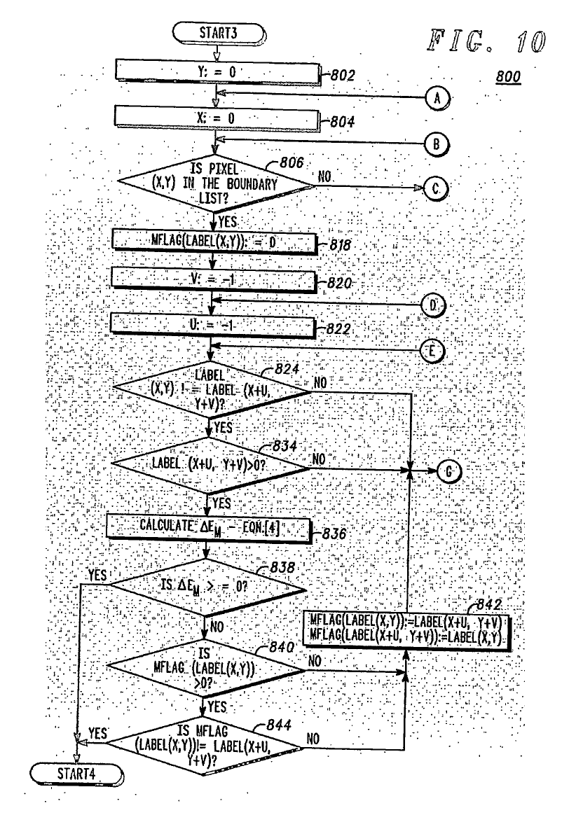

The co-ordinates ‘x’ and ‘y’ in the image are then initialised, as shown in steps 612 and 614. A determination is then made, in step 616, as to whether the pixel at the current x, y co-ordinates is in the list of Boundary pixels. If it is determined at step 616 that the pixel label is not Boundary pixel, the process moves on to the next pixel by incrementing ‘x’ in step 618. If the pixel was in the last column to be checked, i.e. ‘x=M’, in step 620, the process moves to the next pixel row, i.e. y:=y+1, in step 622. A determination is then made as to whether the row was the last row, i.e. ‘y=N’, in step 624. If the row was the last row in step 624, the process moves on to FIG. 7, i step 626.

In the alternative, if the pixel was not a pixel in the last column, in step 620, the pixel label determination process repeats in step 616. Also, if the row was not the last row in step 624, the process repeats at a first pixel in the next row at step 614, i.e. x:=0.

Although the above process illustrates a mechanism for stepping through each and every pixel in determining whether each and every pixel is labelled as s Boundary pixel, it is envisaged that other mechanisms could be employed. For example, it is envisaged that the list of Boundary pixels could be used directly as an input to the segmentation processing at step 628.

Also, a label flag is initialised, i.e. Mflag (x,y):=0, in step 629, which applies only in pixels in the boundary list.

If it is determined in step 616 that the pixel label is a Boundary pixel, the Boundary pixel and, say, preferably the eight neighbouring pixels are processed. This phase of the process commences with initialising the speed of the pixel being processed. The speed is initialised to push out the Boundary pixel, by defining the speed selected is at a pixel co-ordinate of a row less, in step 630, and a column less, in step 632, than the pixel identified as the Boundary pixel.

If the label of the current (neighbouring) pixel is not the same as the Boundary pixel in step 634, the speed of the Boundary pixel is made equal to zero in step 644, and the process returns to the next pixel location in step 618. If the label of the current (neighbouring) pixel and the Boundary pixel are the same in step 634, the next neighbouring pixel is selected, by incrementing the pixel co-ordinate in step 636. If it is not the last neighbouring pixel in the eight-neighbourhood row, in step 638, another neighbouring pixel is process in step 634.

This process reports, moving around the neighbouring pixels (−1<u<=+1, −1<=v<=+1) by incrementing the neighbouring pixel row or column in steps 636-642, until all of the neighbouring pixels have been processed or a neighbouring pixel also has a boundary label.

In this manner, the speed of each Boundary pixel is preset such as to cause the region to grow if all of its 8 neighbouring pixels are also Boundary pixels of the same region label.

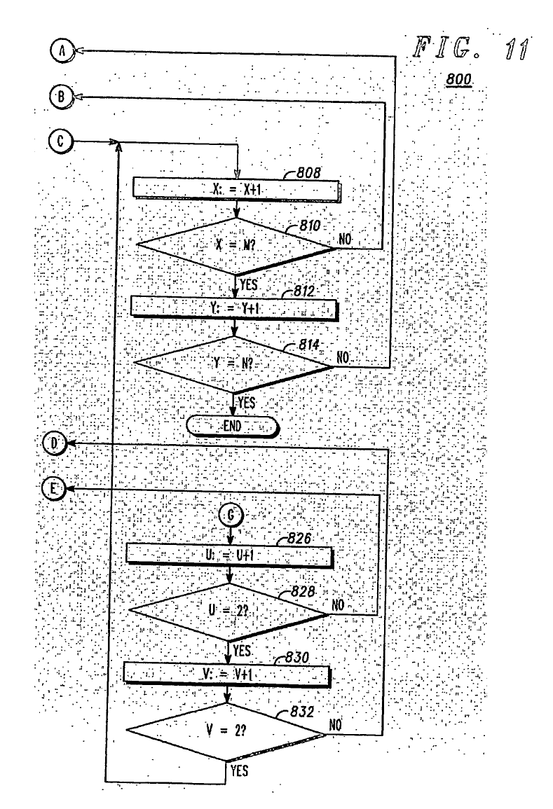

Referring now to FIG. 7, the process continues by re-initialising the pixel coordinates x,y in steps 702, 704. A determination is then made, in step 706, as to whether the pixel, at the current x,y co-ordinates is a Boundary pixel. If it is determined at step 706 that the pixel is not a Boundary pixel, the process moves on to the next pixel by incrementing ‘x’ in step 708. If the pixel was in the last column, i.e. ‘x=M’, in step 710, the process moves to the next pixel row, i.e. y:+1, in step 712. A determination is then made as to whether the row was the last row, i.e. ‘y=N’, in step 714. If the row was the last row in step 714, the process moves on the FIG. 8, in step 716.

In the alternatives, if the pixel was not a pixel in the last column, in step 710, the pixel label determination process repeats in step 706. Also, if the row was not the last row in step 714, the process repeats as a first pixel in the next row at step 704, i.e. x:0.

Again, although the above process illustrates a mechanism for stepping through each and every pixel in determining whether each and every pixel is labelled as a Boundary pixel, it is envisaged that other mechanisms could be employed. For example, it is envisaged that the list of Boundary pixels could be used directly with the pixels indicated on this list being used as input to the segmentation processing at step 718.

If it is determined in step 706 that the pixel is a Boundary pixel, the Boundary pixel and, say, preferably the eight neighbouring pixels are processed. This phase of the process commences with defining the neighbouring pixels. The first neighbouring pixel selected is at a pixel co-ordinate of a row less, in step 718, and a column less, in step 720, than the pixel identified as the Boundary pixel.

If the label of the current (neighbouring) pixel is not the same as the Boundary pixel in step 722, a determination is made as to whether the neighbouring pixel is Foreground or Background, in step 724, as this part of the algorithm is concerned with the competition or merging of Foreground versus Background regions. If the neighbouring pixel is Foreground, the next neighbouring pixel is selected, by incrementing the pixel co-ordinate in step 740. If it is not the last neighbouring pixel in the eight-neighbourhood row, in step 742, another neighbouring pixel is processed in step 722. This process repeats, moving around the neighbouring pixels (−1<=u<=+1, −1<=v<=+1) by incrementing the neighbouring pixel row or column in steps 740-746, until all of the neighbouring pixels have been processed or a neighbouring pixel is found labelled as Background.

If in step 724 the neighbouring pixel is labelled as Background, the process then moves on the calculating the cost of merging ΔE_{M}, in step 726, as shown in equation [4]. If ΔE_{M}≧0, in step 728, then merging increases the total cost, so the regions must compete. If ΔE_{M}<0, then merging will reduce the total cost, so the speed is set to −1, in step 730. The process then moves on the next neighbouring pixel in step 740. If the regions are to compete, ΔE_{M}≧0, then the change in total energy ΔE, is calculated in step 732, as shown in equation [3].

A determination is then made as to whether ΔE>0 in step 734. If the total cost of the movement of the front outwards increases, i.e. ΔE>0 in step 734, then the speed of the Boundary pixel is incremented in step 736. Whereas if ΔE≦0 (i.e. there is a decrease or not change in the global cost) in step 734, then the speed of the convergence is decremented, in step 738, and the region at the Boundary pixel currently under evaluation is allowed to grow outwards. The process then moves on to the next pixel location in step 740.

Also, if ΔE_{M<}0, in step 728, the speed of the Boundary pixel is set to −1, in step 730. The process then moves on to the next neighbouring pixel location in step 740. Once all of the neighbouring pixels have been processed, in step 746, the process moves on to determining whether the next image input pixel is in the boundary pixel list, in step 708.

In this manner, a single iteration of the region competition/merger process for Foreground versus Background pixels around each Boundary pixel is completed.

Referring now to FIG. 8, the process continues by performing region competition/merger operations on Foreground versus Foreground, by re-initialising the pixel coordinates x,y in steps 802, 804. Foreground versus Foreground COMPETE is necessary if a MERGE operation would cause an increase in the global cost. As previously indicated, the desired effect is that one region should push the other away if it causes the global cost to decrease.

A determination is made, in step 806, as to whether the pixel, at the current x,y co-ordinates is a Boundary pixel. If it is determined at step 806 that the pixel is not a Boundary pixel, the process moves on to the next pixel by incrementing ‘x’ in step 808. If the pixel was in the last column, i.e. ‘x=M’, in step 810, the process moves to the next pixel row, i.e. y:=y+1, in step 812.

A determination is then made as to whether the row was the last row, i.e. ‘y=N’, in step 814. If the row was the last row in step 814, the process ends, in step 816. The algorithm then returns to Step 506 of FIG. 5 to test for reaching convergence or a maximum number of iterations.

In the alternatives, if the pixel was not a pixel in the last column, in step 810, the pixel label determination process repeats in step 806. Also, if the row was not the last row in step 814, the process repeats at a first pixel in the next row at step 804.

Again, although the above process illustrates a mechanism for stepping through each and every pixel in determining whether each and every pixel is labelled as a Boundary pixel, it is envisaged that other mechanisms could be employed. For example, it is envisaged that the list of Boundary pixels could be used directly with the pixels indicated on this list being used as input to the segmentation process at step 818.

If it is determined in step 806 that the pixel is a Boundary pixel, the Boundary pixel and, say, preferably the eight neighbouring pixels are processed. The first neighbouring pixel selected is at a pixel co-ordinate of a row less, in step 820, and a column less, in step 822, than the pixel identified as the Boundary pixel.

If the label of the current (neighbouring) pixel is not the same as the Boundary pixel in step 824, a determination is made as to whether the neighbouring pixel is Foreground or Background, in step 834. If the Boundary pixel is Background, there is no need for any further processing of the boundary.

Hence, the next neighbouring pixel is selected, by incrementing the pixel co-ordinate in step 826. If it is not the last neighbouring pixel in the eight-neighbourhood rood, in step 826, another neighbouring pixel is processed in step 824.

This process repeats, moving around the neighbouring pixels (−1<=u<=+1, −1<=v<=+1) by incrementing the neighbouring pixel row or column in steps 826-832, until all of the neighbouring pixels have been processed or a neighbouring pixel is determined as having a different label and therein being a Foreground pixel.

If the neighbouring pixel is labelled as being Foreground, in step 834, then the process moves to calculating the change in total cost in the event of merging ΔE_{M}, in step 836. This is also shown in equation [4]. If ΔE_{M}≧0 in step 838, then merging will cause the cost to increase or remain the same, so that competition should occur.

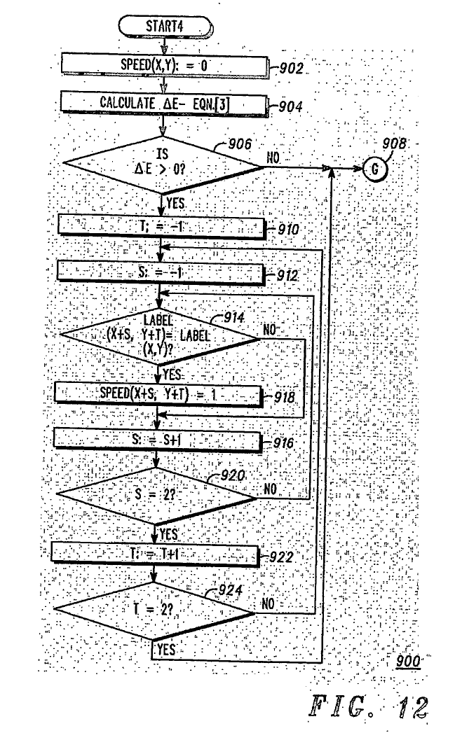

The process moves on to FIG. 9, in step 846. If ΔE_{M}<0, in step 838, then a merger should result in a lower total cost. Therefore, a determination is made as to whether Mflag(label(x,y))>0, in step 840. This test whether, for this region, the pixel at co-ordinates x,y is assigned for merging in this current iteration.

If Mflag(label(x,y))>0, is step 840, this indicates that this region is marked for merging with another. If this is the case, a determination is made as to whether the Mflag(label(x,y)) label is the same as the neighbouring label, in step 844. If the Mflag(label(x,y)) label is not the same as the neighbouring label, in step 844, the process moves on to FIG. 9. These steps ensure that only pairs of regions whose merger will reduce global cost, are allowed to merge. The flag for the region label is set to the label with which it is to be merged at the end of the current iteration. Otherwise, the flag is set to zero.

If Mflag(label(x,y))≦0, in step 840, or the Mflag(label(x,y)) label is the same as the neighbouring label, in step 844, the label assigned to the Mflag neighbour is made equal to the boundary label. In addition, the label assigned to the Mflag of the Boundary label is made equal to the label of the neighbouring pixel. Then the process moves on to operate on the next neighbouring pixel, in step 826.

Referring now to FIG. 9, a flowchart 900 is shown that describes the competition between Foreground regions. The flowchart 900 commences by initialising the speed at Boundary pixel (x,y) to zero, in step 902. The process then calculates the change in total cost in the event of the contour at the current boundary growing outwards, ΔE, in step 904, in line with equation [3].

A determination is then made as to whether ΔE>0 in step 906. If ΔE≦0 in step 906, then the current Boundary pixel is deemed statistically more similar to the region with which it is associated, than the region associated with the neighbouring pixel. In this case, the next neighbouring pixel is processed, in step 880 of FIG. 8.

If ΔE>0 in step 906, then the process commences with defining the neighbouring pixels, The first neighbouring pixel selected is at a pixel co-ordinate of a row less, in step 910, and a column less, in step 912, than the pixel identified as the Boundary pixel.

If the label of the current (neighbouring) pixel is not the same as the Boundary pixel in step 914, the neighbouring pixel in the next column is selected by incrementing the pixel co-ordinate in step 916. If it is not the last neighbouring pixel in an eight-neighbourhood column, in step 920, another neighbouring pixel in the next row is selected for processing in step 922.

This process repeats, moving around the neighbouring pixels (−1<=s<=+1, −1<=t<=+1) by incrementing the neighbouring pixel row or column in steps 916-924, until all of the neighbouring pixels have been processed.

If ΔE>0, then the Boundary pixel is more similar to the region associated with the neighbouring pixel than it is with the region it is currently associated with. In this case, the region with which it is associated should be caused to shrink. This is done by setting the speed of the current Boundary pixel (x,y) and that of its eight-neighbourhood, which share the same label and hence belong to the same region, to ‘1’, in step 918.

The effect of this process is that, at each iteration, regions that are similar to Boundary pixels ‘grow’ in the direction of those Boundary pixels. Another way to view this is that the boundary will move in the direction of the region that has a ‘weaker’ statistical force with respect to the Boundary pixel under consideration. As explained earlier, in this context a ‘weaker’ statistical force means that the region is less similar to the Boundary pixel. As also explained earlier, the similarity is estimated by gathering the statistics in a local window around the Boundary pixel.

Once all of the neighbouring pixels have been processed, in step 924, the process moves on to determining the next neighbouring pixel with Foreground label, in step 880.

This defines a single complete iteration of the segmentation process. The algorithm can be repeated as many times as required, as shown in FIG. 5.

The aforementioned flowcharts indicate the preferred order of steps in employing the inventive concepts. However, it is envisaged that a different order of steps, including deleting or adding further steps may be used for different applications or scenarios. Thus, the preferred order should not be viewed as the only order of events and steps in which to employ the aforementioned inventive concepts.

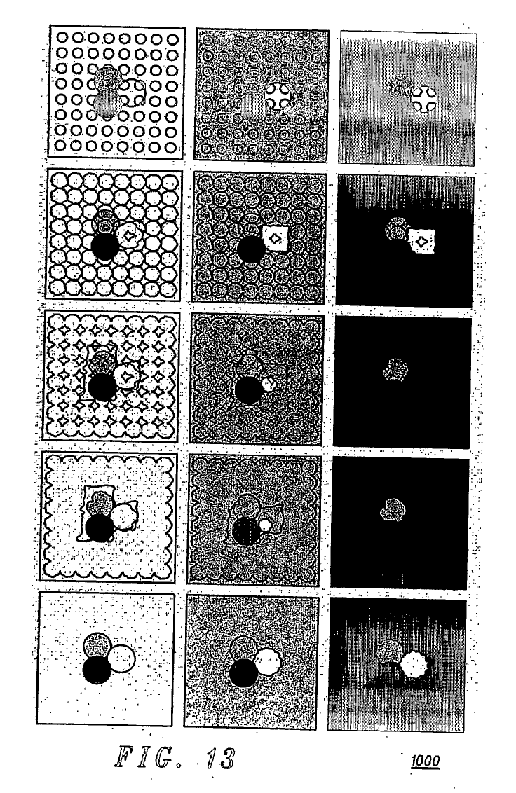

Referring now to FIG. 10, results of the segmentation process of the aforementioned flowcharts are illustrated. The image is of three circles of different grey levels in Gaussian noise with variance of 0.3, 0.5 and 1.0 referring to the left, centre and right-hand columns respectively. A Gaussian model was selected, with parameters of LocalScale=3, Lambda=50.

The pictures intentionally illustrate a noisy environment to show that the method works in the presence of variable image noise. There are three noise conditions illustrated (shown in columns) and five pictures for each example iterative step (as the picture moves vertically down the column).

FIG. 10 illustrates the operation of the algorithm, from initialisation of the seed regions (top row) to completion of the segmentation (bottom row). Each image in the top row (representing different values of additive Gaussian noise) is initialised with circular seed regions. Pixels are defined as Boundary pixels (i.e. those lying on the notional black circle boundaries), Foreground pixels (i.e. those pixels within the boundaries and include the boundaries), and Background pixels (i.e. those pixels outside the boundaries).

In the second row, a number of iterations of the algorithm have taken place, such that the Foreground regions have grown, and some are beginning to compete and merge.

As will be seen in the third and fourth rows of FIG. 10, regions that are in the area outside of the three grey level circles are caused to shrink during successive repeated iterations of the algorithm. In contrast, the regions inside and around the grey level circles are caused to merge. This leads to a single boundary being located around these circles by the time that a total number of iterations of the algorithm have been allowed to take place. This, in turn, leads to the figures shown in the final row of FIG. 10. After this number of iterations, the algorithm is deemed to have reached convergence, i.e. no further iterations will improve on the accuracy of the resulting boundaries that have been calculated.

In the preferred embodiment of the present invention, it is noteworthy that the exact number of iterations, as specified in the above flowcharts, is not critical to the process. In particular, it is envisaged that larger or smaller neighbourhood windows may be used. Furthermore, a ‘consensus’ choice of whether to merge or compete may be applied across the window rather than the implementation described below.

It is further envisaged that, in alternative embodiments, Level Set methods can be implemented using finite difference approximation methods as described in the known Level Sets literature. In this implementation, the following finite difference approximation has been used:

$${F}_{Region} \vert ∇ ψ \vert \approx max ( {F}_{{R}_{ij}} , 0 ) {∇}^{+} + min ( {F}_{{R}_{ij}} , 0 ) {∇}^{-} \\ {∇}^{+} = {[ {max ( {D}_{ij}^{- x} , 0 )}^{2} + {min ( {D}_{ij}^{+ x} , 0 )}^{2} + {max ( {D}_{ij}^{- y} , 0 )}^{2} + {min ( {D}_{ij}^{+ y} , 0 )}^{2} ]}^{1 / 2} \\ {∇}^{-} = {[ {max ( {D}_{ij}^{+ x} , 0 )}^{2} + {min ( {D}_{ij}^{- x} , 0 )}^{2} + {max ( {D}_{ij}^{+ y} , 0 )}^{2} + {min ( {D}_{ij}^{- y} , 0 )}^{2} ]}^{1 / 2} \qquad [ 7 ]$$

where Dᵢⱼ^{-x}, Dᵢⱼ^{+x}, Dᵢⱼ^{-y} and Dᵢⱼ^{+v} represent one-sided finite differences in the −x, +x, −y and +y directions respectively.

Another point of note, regarding the implementation of the inventive concepts described herein, is that Level Set methods are generally-speaking computationally very expensive. Several techniques have been devised to speed them up. One example is the Narrow Band technique described by D. Adalsteinsson and J. Sethian in ‘A fast level set method for propagating interfaces’, published in the Journal of Computational Physics, vol. 118, no. 2, pages 269-277, 1995. The Narrow Band method provides significant computational savings over the standard method, and is therefore adopted in the preferred implementation.

Non-Parametric Region Competition Cost Functions

The standard Region Competition evolution equations, and in fact most of the statistical region based segmentation methods, assume parametric PDFs for modelling the regions, often assuming a Gaussian-like PDF. The reasons are mainly mathematical tractability. At first glance, it may seem that this model is over simplistic since many images are not composed of Gaussian-like patches.

However, as long as suitable statistical tests are used, i.e. the regions to be segmented can be differentiated, the assumption works quite satisfactorily. For example, in many cases, although the regions contain quite non-Gaussian PDFs they might still be differentiated by a mean and variance test, such as that used in standard region competition.

However, the Gaussian assumption does require very careful setting of the initial seed size, size of the Local window and merge cost parameters. If the size of the local window over which statistics around a Boundary pixel are gathered is insufficiently large, then a region may be broken up into many small pieces whereas in fact they are part of the same region. On the other hand, making the size of this local window too large decreases the accuracy of the boundary localisation.

Using an alternative more accurate model would overcome this problem. The method would then become more robust and less sensitive to initialisation settings and cost parameters. Furthermore, for cases where there is a large number of classes, or the regions cannot be differentiated by mean and variance tests, a non-parametric model is essential.

In this regard, equation [3] is replaced with:

$$Δ {E}_{( x , y )} = {\sum }_{d ∈ D} {p}_{{w}_{( x , y )}} ( d ) log ( {p}_{{R}_{j}} ( d ) ) - {\sum }_{d ∈ D} {p}_{{w}_{( x , y )}} ( d ) log ( {p}_{{R}_{i}} ( d ) ) \qquad [ 8 ]$$

Each summation term in Equation [8] simply represents the cross-entropy between the PDF of the pixels in the local window around x=(x,y) and the PDF of the pixels in regions Rⱼ and Rᵢ respectively. Equation [5] is replaced with:

$$Δ {E}_{M} = - λ + {n}_{{ℛ}_{i}} {\sum }_{d ∈ D} {p}_{{ℛ}_{i}} ( d ) log {p}_{{ℛ}_{i}} ( d ) + {n}_{{ℛ}_{j}} {\sum }_{d ∈ D} {p}_{{ℛ}_{j}} ( d ) log {p}_{{ℛ}_{j}} ( d ) - {n}_{{ℛ}_{ij}} {\sum }_{d ∈ D} {p}_{{ℛ}_{ij}} ( d ) log {p}_{{ℛ}_{ij}} ( d ) \qquad [ 9 ]$$

This is simply the sum of the entropies of regions Ri and Rj minus the entropy of the combined region Rij.

In alternative embodiments of the present invention, it is envisaged that different attributes may be used to drive the segmentation. One approach would be to use the image pixel intensities directly.

Alternatively, texture features may be used. For these, the inventors of the present invention recommend that the non-parametric version of Region Competition should be used, as the probability density functions (PDFs) of these features are typically non-Gaussian. Many different texture descriptors could be used.

One approach is to use the Scale Descriptor method described in co-pending UK Patent Application GB 0024669.4 filed in May, 2001, by the same applicant as the present invention. Here the texture is represented as the PDF of Salient Scales as found by using the Scale Saliency method described in co-pending UK Patent Application GB 0112540.0, filed in October 2000 by the same applicant as the present invention. Either the 1-D (PDF of scales) or 2D (joint salient scale and saliency PDF) descriptors can be used. As such, the texture descriptor mechanisms described in UK Patent Application GB 0024669.4. and UK Patent Application GB 0112540.0 are incorporated herein by reference.

For each region (or local window) a PDF (approximately by a histogram) of salient scales, or 2-D joint PDF of salient scales and corresponding saliency values, is generated and used to calculate the cost functions as described above. Preferably, the counts in the histograms are weighted by the saliency value to reduce the effect of low saliency features.

Segmentation is an essential first step in object-based video compression (e.g. MPEG-4 core profile), object-based image and video indexing and searching, image and video based defect detection systems, people and object tracking for security applications, and image analysis. Thus, it is envisaged that the segmentation algorithm described herein would benefit each of the above video applications. In this manner, the algorithm provides a highly reliable and reduced complexity image segmentation method.

Although the preferred embodiment of the present invention has been described with regard to an eight-pixel neighbourhood, a skilled artisan would appreciate. that alternative embodiments may use a different number of pixels, dependent upon the prevailing conditions.

It is envisaged that any video or image communication unit may benefit from the inventive concepts described herein. Furthermore, it is within the contemplation of the invention that the video or image communication unit may be any wireless communication device, such as a portable or mobile PMR radio, a mobile phone, a personal digital assistant, a wireless laptop computer, etc.

A skilled artisan will appreciate that the inventive concepts of the present invention can be applied to any signal processing function of such image or video communication devices. In the preferred embodiment of the present invention, such a signal processing function has been adapted to perform image segmenting as described above.

More generally, any re-programming or adaptation of one or more software algorithms or data banks of a video or image processor within the video or image communication unit, may be implemented in any suitable manner. For example, a new signal processor function or memory device may be added to a conventional video or image communication unit. Alternatively, existing parts of a conventional video or image communication unit may be adapted, for example by reprogramming one or more processors therein. As such, the required adaptation may be implemented in the form of processor-implementable instructions stored on a storage medium, such as a floppy disk, hard disk, PROM, RAM or any combination of these or other storage media.

The preferred embodiment of the present invention has been described with reference to a conventional Region Competition piecewise constant cost function, due to its simplicity. However, for example, in an alternative application it is envisaged that a piecewise smooth model could be used to overcome some of the problems associated with a piecewise constant model.

As multimedia communication systems become commodities in the future, technologies such as those offered by this invention will enable users to efficiently communicate key features of an image, without having to pay for expensive bandwidth in order to send the entire image itself. It is envisaged that the inventive concepts described herein could be incorporated into any mobile image and/or video communication device, and as such has broad applicability.

It is within the contemplation of the invention that any system requiring image segmentation as a pre-processing stage may benefit from the inventive concepts described above. For example, it is envisaged that the inventive concepts can be applied in at least some of the following applications:
(i) The industrial inspection domain, for example seeking defects in textiles;
(ii) Medical applications, for example cell counting;
(iii) MPEG-4 core profile image compression;
(iv) Object-based metadata association for interactive television;
(v) Any surface where a defect would reduce the value of a product;
(vi) Database searching, for example fashion and art image databases;
(vii) Terrain classification, for example for military and commercial uses; and
(viii) Object tracking for surveillance, etc.

It will be understood that the communication system, communication unit and method for segmenting a region within images as described above, tends to provide, either singly or in combination, at least some of the following advantages:
(i) Unsupervised image segmentation of an arbitrary number of classes;
(ii) High generality of application, since the characteristics of the classes do not have to be set a-priori; and
(iii) A highly computationally efficient algorithm, when compared to known level sets techniques or region competition techniques operating singly.

In summary, known N-class region segmentation methods, such as conventionally implemented Region Competition represent regions by means of region membership arrays. Typically, such methods lack an intrinsic curve model that necessitates explicit handling of situations where multiple regions meet and compete. In contrast, the preferred embodiment of the present invention employs Region Competition within a Level Set framework. Known N-class Level Set based region segmentation algorithms use multiple-coupled regions in parallel, which is inefficient and does not facilitate completely unsupervised algorithm.

Advantageously, this is not a limitation of the present invention. This improvement is achieved by using only one embedded function and controlling the merging and splitting behaviour of the zero Level Set according to a Region Competition cost function by means of a layer of region control logic.

Advantageously, the present invention allows both the standard Gaussian Region Competition cost function and incorporates a more general non-parametric version.

Thus, an image transmission system, an image transmission unit and a method for segmenting a region in an image have been provided wherein the abovementioned disadvantages associated with prior art arrangements have been substantially alleviated.

1. A method (500) for segmenting an image, the method comprising the step of:
identifying (502) one or more regions in said image;
the method characterised by the steps of:
applying a single embedded surface for a Level Sets representation of said image; and
performing region control logic (504) to enable said Level Sets representation to manipulate one or more region boundaries in order to segment said image.

2. The method for segmenting an image according to claim 1, wherein the step of performing region control logic comprises the steps of:
applying a region competition cost function to said image to determine how to manipulate said one or more boundaries.

3. The method for segmenting an image according to claim 2, where said cost function comprises a curvature dependent term as a boundary cost.

4. The method for segmenting an image according to claim 2, the method further characterised by the step of:
calculating a global cost in said region competition cost function and performing region control logic to minimise a value of said calculated global cost.

5. The method for segmenting an image according to claim 1, wherein the step of performing region control logic comprises the step of performing merge or compete operations of a zero level set by means of a contour speed function.

6. The method for segmenting an image according to claim 1, wherein the step of applying a single embedded surface represents any number of disconnected regions, the method further characterised by the step of:
applying a pixel-labelling algorithm to identify disconnected regions separately.

7. The method for segmenting an image according to claim 6, wherein the step of applying a pixel-labelling algorithm is used at each iteration of a boundary curve evolution, to identify disconnected regions and/or to extract the Foreground/Background region labels.

8. The method for segmenting an image according to claim 6, the method further characterised by the step of:
assigning neighbouring pixels of a region with the same label such that a region is able to grow or shrink over the Boundary pixels.

9. The method for segmenting an image according to claim 1, wherein the step of performing region control logic comprises the step of:
performing a merge operation on Boundary pixels of said one or more regions of said image, or
performing a compete operation on Boundary pixels of said one or more regions of said image, such that said one or more regions are able to grow or shrink.

10. The method for segmenting an image according to claim 9, the method further characterised by the step of:
setting one or more speeds on said embedded surface to control said merging or competing operations.

11. The method for segmenting an image according to claim 9, wherein the step of merging is restricted such that only unique pairs of regions are merged at any single iteration of performing region control logic.

12. The method for segmenting an image according to claim 9, the method further characterised by the step of:
applying one or more merge flags to said one or more regions;
wherein a status of said one or more merge flags of each region in a pair of regions under consideration are assessed before proceeding to said step of performing a merge operation.

13. The method for segmenting an image according to claim 1, wherein the step of identifying comprises identifying two or more of: a Foreground region of said image, a Background region of said image and/or a boundary of said image, in a Level Sets framework.

14. The method for segmenting an image according to claim 13, wherein said Foreground region is defined as a region where the embedding surface (ψ) has a value greater than zero and also includes negative or zero boundary terms adjacent to said region.

15. (canceled)

16. The method for segmenting an image according to claim 13, wherein the step of applying a pixel-labelling algorithm comprises applying a positive label to a Foreground region and a negative label to a Background region,
the method further characterised by the step of:
conducting a local search, for example in an eight-pixel neighbourhood, around a Boundary pixel under consideration in order to detect whether a region adjacent to a Boundary pixel is a Foreground region or a Background region.

17. The method for segmenting an image according to claim 16, wherein a Foreground region is deemed present where any pixel in said local search is detected as having a positive label that differs from that of the Boundary pixel under consideration.

18. The method for segmenting an image according to claim 16, wherein a Background region is deemed present where any pixel in said local search is detected as having a negative label that differs from that of the Boundary pixel under consideration.

19. The method for segmenting an image according to claim 16, wherein any Boundary pixel identified as being adjacent to a further Boundary pixel from a same region is configured to grow prior to performing region competition control logic.

20. The method for segmenting an image according to claim 16, the method further characterised by the step of:
enabling Foreground-to-Foreground region competition by causing one region to shrink.

21. The method for segmenting an image according to claim 1, wherein said Level Set representation is implemented using a finite difference approximation to take into account a direction of surface movement.

22. Currently Amended) The method for segmenting an image according to claim 1, wherein said step of identifying one or more regions in said image identifies attributes of said image.

23. The method for segmenting an image according to claim 22, wherein said step of identifying comprises identifying one or more of the following attributes of said image: image pixel intensities, texture features, colour, edge distribution.

24. The method for segmenting an image according to claim 1, the method further characterised by the step of:
applying a cost function to said labelled pixels to determine whether to perform a merging or competing operation of said pixels.

25. (canceled)

26. (canceled)

27. (canceled)
